(19) United States
(12) Patent Application Publication
(10) Pub. No.: US 2017/0291060 A1
(43) Pub. Date: Oct. 12, 2017

(54) YOGA PAD AND METHOD FOR MAKING THE SAME

(71) Applicant: MENG CHIEN LIN, TAICHUNG CITY (TW)

(72) Inventor: MENG CHIEN LIN, TAICHUNG CITY (TW)

(21) Appl. No.: 15/481,482

(22) Filed: Apr. 7, 2017

(30) Foreign Application Priority Data
Apr. 11, 2016 (TW) 105111163

(51) Int. Cl. A63B 21/00; B32B 5/02; B32B 37/12; B32B 7/12; B32B 27/12; B32B 5/18; B32B 5/24

(52) U.S. Cl. CPC A63B 21/4037; B32B 5/18; B32B 5/024; B32B 5/028; B32B 5/245; B32B 7/12; B32B 27/12; B32B 37/12; B32B 2250/04; B32B 2262/062; B32B 2262/0276; B32B 2305/022; B32B 2305/18

(57) ABSTRACT

A method for making a yoga pad includes a step of preparing a netted base; a step of cutting the netted base into two adhesive units; a step of attaching a foam pad to the netted layer of one of the adhesive layers; and a step of adhering a towel to the C-shaped resilient members of the adhesive layer to form a yoga pad. The C-shaped resilient members are combined with the fibers on the towel in axial direction so that the foam pad is detachably connected to the towel. The fibers of the towel are engaged with the openings of the free ends of the C-shaped resilient members to provide a resistance in lateral direction to the towel which does not easily shift relative to the foam pad.

### BACKGROUND OF THE INVENTION

### 1. Fields of the Invention

The present invention relates to a yoga pad and a method for making the yoga pad.

### 2. Descriptions of Related Art

Yoga pads are designed to support the user's body and provide proper friction so that the user does not slip. It is noted that the material of the conventional yoga pads has slightly expandable, so that some users put a piece of towel on the yoga pad to prevent from slipping. Nevertheless, the towel may shift along with movement of the users. In order to improve the shortcoming, some manufacturers secure a towel to the yoga pad by way of heat-pressing or using adhesive.

However, the towel on the surface of the yoga pad absorbs sweat and easily gets dirt. The towel on the yoga pad is not easily cleaned up due to it is combined with the yoga pad, and the yoga pad is too big to be easily cleaned.

The present invention intends to provide a yoga pad and a method for making the yoga pad, wherein the towel is easily attached to and removed from the base of the yoga pad.

### SUMMARY OF THE INVENTION

The present invention relates to a method for making a yoga pad, and the method comprises a step of preparing a netted base; a step of cutting the netted base into two adhesive units; a step of attaching a foam pad to the netted layer of one of the adhesive layers; and a step of adhering a towel to the C-shaped resilient members of the adhesive layer to form a yoga pad. The C-shaped resilient members are combined with the fibers on the towel in axial direction so that the foam pad is detachably connected to the towel. The fibers of the towel are engaged with the openings of the free ends of the C-shaped resilient members to provide a resistance in lateral direction to the towel which does not easily shift relative to the foam pad.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the of the yoga pad of the present invention;

FIG. 2 is another exploded view of the of the yoga pad of the present invention;

FIG. 3 is a perspective view to show the yoga pad of the present invention;

FIG. 4 is a cross sectional view of the yoga pad in FIG. 3;

FIG. 5 is an exploded view of the second embodiment of the yoga pad of the present invention;

FIG. 6 is a cross sectional view of the yoga pad in FIG. 5;

FIG. 7 shows the steps of the method for making the yoga pad of the present invention.

### DETAILED DESCRIPTION OF THE PREFERRED EMBODIMENT

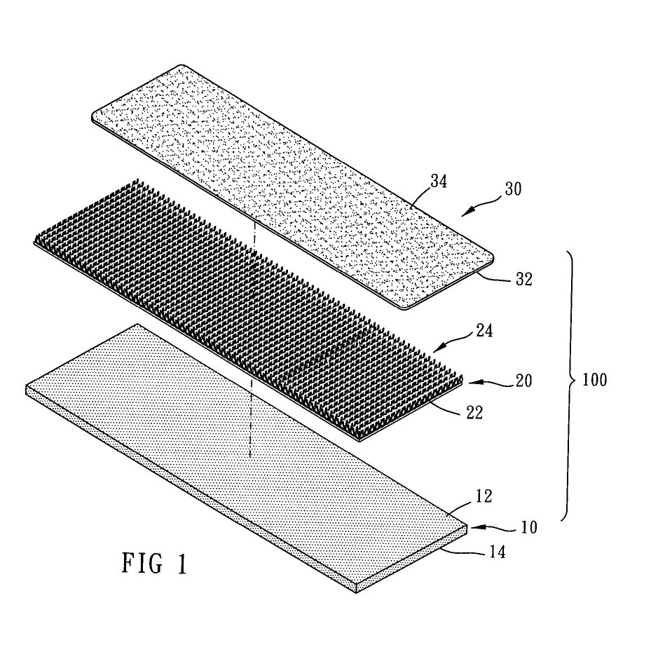

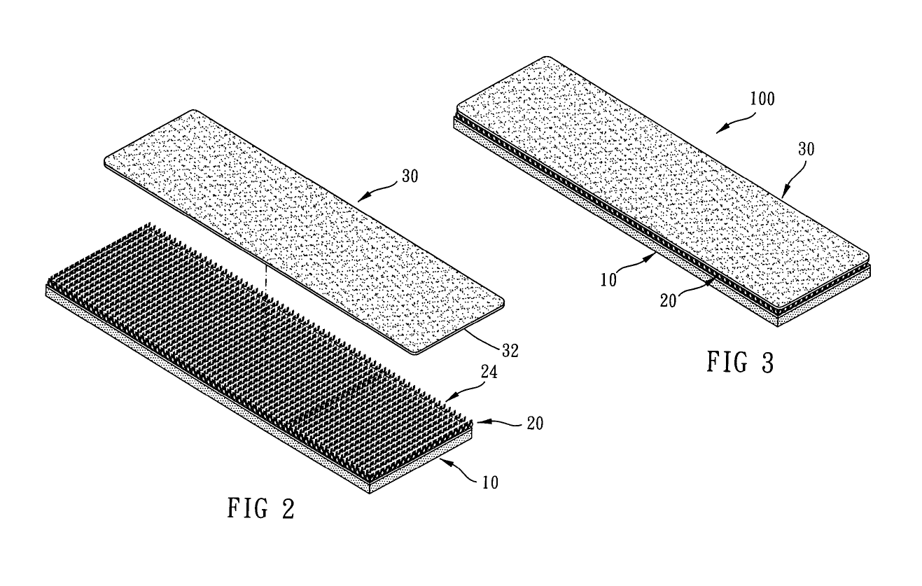

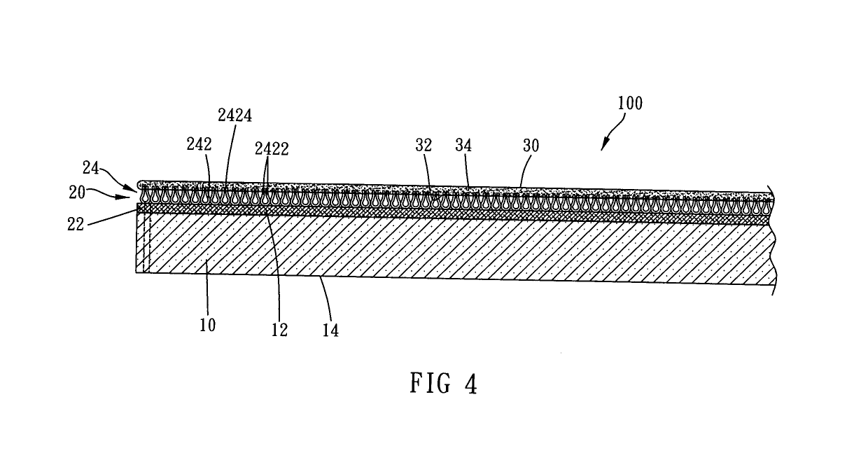

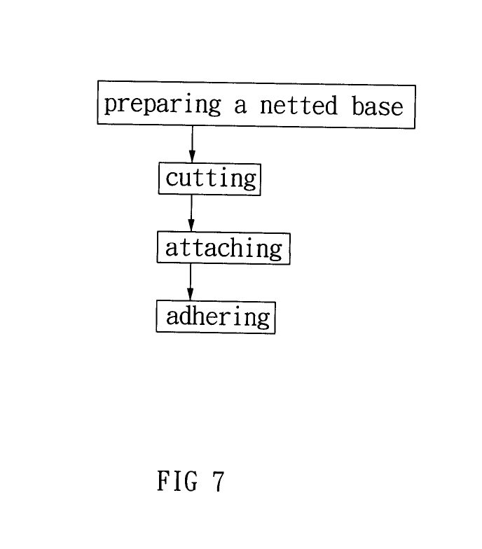

Referring to FIGS. 1 to 4 and 7, the method for making a yoga pad of the present invention comprises a step of preparing a netted base: preparing a first netted layer, a second netted layer and multiple ring-shaped resilient members which are connected between the first and second netted layers;

a step of cutting: cutting the netted base into two adhesive units 20, each adhesive unit 20 having a netted layer 22 and an adhesive layer 24 which is secured to a surface of the netted layer 22, the adhesive layer 24 having multiple C-shaped resilient members 242 which are formed by cutting the ring-shaped resilient members into halves;

a step of attaching: preparing a foam pad 10 which includes a first surface 12 and a second surface 14, the netted layer 22 of one of the adhesive units 20 being connected to the first surface 12 of the foam pad 10, and

a step of adhering: preparing a towel 30 having a third surface 32 and a fourth surface 34, the third surface 32 having multiple fibers which are adhered to the C-shaped resilient members 242 of the adhesive layer 24 to form a yoga pad 100.

The yoga pad 100 of the present invention comprises a foam pad 10 which is a rectangular pad and is made of PVC, PET, PU, PP, or PE, and the foam pad 0 has a first surface 12 and a second surface 14. A netted base includes a top netted layer, a bottom netted layer and multiple ring-shaped resilient members connected between the top and the bottom netted layers. The netted base is cut into two halves to form two adhesive units 20, and each adhesive unit 20 includes a netted layer 22 and an adhesive layer 24 on the surface of the netted layer 22. The adhesive layer 24 includes multiple C-shaped resilient members 242 which are the halves of the ring-shaped resilient members. The C-shaped resilient members 242 of the adhesive layer 24 are arranged in multiple matrixes, and a gap is formed between the matrixes. Each C-shaped resilient member 242 has two free ends 2422, and an opening 2424 is defined between the free ends 24222. The netted layer 22 is connected to the first surface 12 of the foam pad 10. A towel 30 includes a third surface 32 and a fourth surface 34. Each of the third and fourth surfaces 32, 42 has multiple fibers. The fibers are cotton fibers or polyester fibers. The towel 30 is detachably connected to the adhesive layer 24, and the fibers on the third surface 32 are connected to the C-shaped resilient members 242 of the adhesive layer 24 to form a yoga pad 100. Specifically, the fibers of the towel 30 are inserted into the gaps and the openings 2424 of the C-shaped resilient members 242. The two free ends 2422 of the C-shaped members 242 are engaged with the third surface 32 to provide a resistance to the towel 30 in lateral direction.

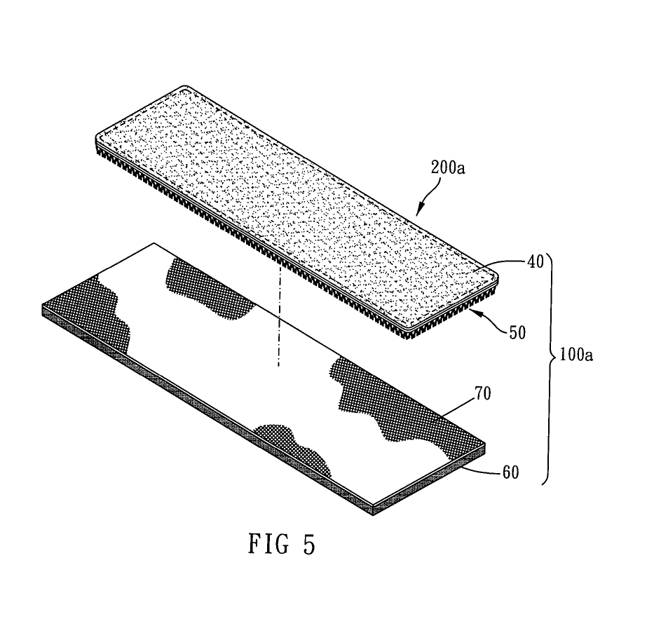

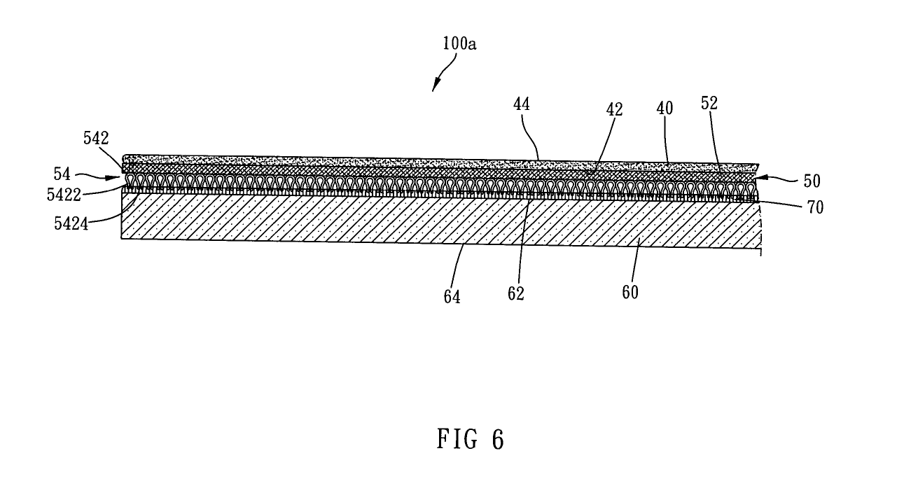

FIGS. 5 to 8 show the second embodiment of the method for making a yoga pad 100a, the method comprises:

a step of preparing a netted base: preparing a first netted layer, a second netted layer and multiple ring-shaped resilient members which are connected between the first and second netted layers;

a step of cutting: cutting the netted base into two adhesive units 50, each adhesive unit 50 having a netted layer 52 and an adhesive layer 54 which is secured to the surface of the netted layer 52, the adhesive layer 54 having multiple C-shaped resilient members 542 which are formed by cutting the ring-shaped resilient members into halves;

a step of attaching: preparing a towel 40 having a third surface 42 and a fourth surface 44, the third surface 42 connected to the netted layer 52 of one of the adhesive units 50 to form a yoga sheet 200a, and

a step of adhering: preparing a foam pad 60 which includes a first surface 62 and a second surface 64, the first surface 62 of the foam pad 60 adhered to a second towel 70 which has a fifth surface having fibers, the fibers on the fifth surface of the second towel 70 adhered to the C-shaped resilient members 542 of the yoga sheet 200a to form a yoga pad 100a.

The yoga pad 100a made by the second embodiment of the method of the present invention comprises a towel 40 having a third surface 42 and a fourth surface 44. An adhesive unit 50 has a netted layer 52 and an adhesive layer 54 on the netted layer 52. The netted layer 52 is connected to the third surface 42 of the towel 40 to form a yoga sheet 200a by way of heat pressing or any known method. The adhesive layer 54 has multiple C-shaped resilient members 542 which are formed by cutting the ring-shaped resilient members into two halves. Each C-shaped resilient member 542 has two free ends 5422 and an opening 5424 is formed between the two free ends 5422. A foam pad 60 has a first surface 62 and a second surface 64. A second towel 70 is connected to the first surface 62, and has a fifth surface which has multiple fibers. The fibers are cotton fibers or polyester fibers. The foam pad 60 is detachably connected to the adhesive layer 54 of the yoga sheet 200a by adhering the fibers on the fifth surface of the second towel 70 to the adhesive layer 54 so as to form a yoga pad 100a.

Specifically, the C-shaped resilient members 542 of the adhesive layer 54 are arranged in multiple matrixes, and a gap is formed between the matrixes. The fibers of the fifth surface of the second towel 70 are inserted into the gaps and the openings 5424 of the C-shaped resilient members 542. The two free ends 5422 of the C-shaped members 542 are engaged with the fifth surface 32 to provide a resistance to the towel 40 in lateral direction.

Although the adhesive units are connected to the whole surface of the foam pad or the towel, the adhesive units may connect to a portion of the surface of the foam pad or the towel.

The ring-shaped resilient members are cut into two halves to form C-shaped resilient members. The C-shaped resilient members are formed on each of the adhesive units, and can be connected to the fibers of the towel or the foam pad. The C-shaped resilient members allow the towel or the foam pad to be easily peeled off from the yoga pad to be cleaned up.

The two free ends of the C-shaped resilient members are engaged with the fibers of the towel and provide a resistance in the lateral direction, so that the towel does not shift laterally relative to the foam pad.

The C-shaped resilient members 542 of the adhesive layer 54 are arranged in multiple matrixes, and a gap is formed between the matrixes. The fibers of the fifth surface of the second towel 70 are inserted into the gaps and the openings 5424 of the C-shaped resilient members 542. The two free ends 5422 of the C-shaped members 542 are engaged with the fifth surface 32 to provide a resistance to the towel 40 in lateral direction. Therefore, the towel or the foam pad is easily peeled off in the axial direction.

It is noted that the conventional hook-and-loops strips can only be peeled off within limited times. On the contrary, the C-shaped resilient members of the adhesive units of the present invention do not have hooks and are shaped as smooth C shape, so that the fibers on the towel are not broken. The towel and the foam pad can be peeled off while the fibers and the C-shaped resilient members are remained the same.

The netted base can be easily purchased in the market and a simple cutting step applied to the netted base can get the C-shaped resilient members.

While we have shown and described the embodiment in accordance with the present invention, it should be clear to those skilled in the art that further embodiments may be made without departing from the scope of the present invention.

What is claimed is:

1. A method for making a yoga pad, comprising:
a step of preparing a netted base: preparing a first netted layer, a second netted layer and multiple ring-shaped resilient members which are connected between the first and second netted layers;
a step of cutting: cutting the netted base into two adhesive units, each adhesive unit having a netted layer and an adhesive layer which is secured to a surface of the netted layer, the adhesive layer having multiple C-shaped resilient members which are formed by cutting the ring-shaped resilient members into halves;
a step of attaching: preparing a foam pad which includes a first surface and a second surface, the netted layer of one of the adhesive units being connected to the first surface of the foam pad, and
a step of adhering: preparing a towel having a third surface and a fourth surface, the third surface having multiple fibers which are adhered to the C-shaped resilient members of the adhesive layer to form a yoga pad.

2. A yoga pad comprising:
a foam pad having a first surface and a second surface;
an adhesive unit having a netted layer and an adhesive layer on a surface of the netted layer, the adhesive layer having multiple C-shaped resilient members, each C-shaped resilient member having two free ends, an opening defined between the free ends, the netted layer connected to the first surface of the foam pad, and
a towel having a third surface and a fourth surface, the third surface having multiple fibers, the towel detachably connected to the adhesive layer, the fibers on the third surface connected to the C-shaped resilient members of the adhesive layer to form a yoga pad.

3. The yoga pad as claimed in claim 2, wherein the C-shaped resilient members of the adhesive layer are arranged in multiple matrixes, a gap is formed between the matrixes, the fibers of the towel are inserted into the gaps and the openings of the C-shaped resilient members, the two free ends of the C-shaped members are engaged with the third surface to provide a resistance to the towel in lateral direction.

4. The yoga pad as claimed in claim 3, wherein the fibers are cotton fibers or polyester fibers.

5. A yoga pad comprising:
a towel having a third surface and a fourth surface;
an adhesive unit having a netted layer and an adhesive layer on the netted layer, the netted layer connected to the third surface of the towel to form a yoga sheet, the adhesive layer having multiple C-shaped resilient members, each C-shaped resilient member having two free ends and an opening formed between the two free ends, and
a foam pad having a first surface and a second surface, a second towel connected to the first surface and having a fifth surface which has multiple fibers, the foam pad detachably connected to the adhesive layer of the yoga sheet by adhering the fibers on the fifth surface of the second towel to the adhesive layer so as to form a yoga pad.

6. The yoga pad as claimed in claim 5, wherein the C-shaped resilient members of the adhesive layer are arranged in multiple matrixes, a gap is formed between the matrixes, the fibers of the fifth surface of the second towel are inserted into the gaps and the openings of the C-shaped resilient members, the two free ends of the C-shaped members are engaged with the fifth surface to provide a resistance to the towel in lateral direction.

7. The yoga pad as claimed in claim 6, wherein the fibers are cotton fibers or polyester fibers.
